(19) United States
(12) Patent Application Publication
(10) Pub. No.: US 2007/0011177 A1
(43) Pub. Date: Jan. 11, 2007

(54) Metadata-based form rendering and write-back

(75) Inventors: Alisson A.S. Sol, Redmond, WA (US); Peter Eberhardy, Seattle, WA (US); Xiaohong Mark Yang, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/175,701

(22) Filed: Jul. 5, 2005

(51) Int. Cl. G06F 7/00

(52) U.S. Cl. 707/100

(57) ABSTRACT

RDL (report description language) is an XML-based schema that has been designed and extended for standardizing report generation and maintenance. Reports can be generated that allow inspection of data that can come from several sources. The data can come from several arbitrary data sources, which can then be obtained and displayed using RDL. Implementations are provided for creating a mechanism to define how to present to end-users existing data, indicate where writing is possible, capture the user input, and later submit the changed data back to the data repository. Accordingly, a “Form” is defined, which provides a “report with data entry” areas.

### BACKGROUND

Some application programs use and generate data files that can be opened, saved and saved as new data files. For example a word processing application can be used to generate and edit a text document (i.e., a type of data file). A file may include metadata in addition to the data. Metadata can be used, for example, to provide formatting information used in displaying and/or printing the data contained in the file.

Business users frequently need to create reports, which should properly transform and format data for human inspection. Usually, such reports present data coming from read-only data sources such as from relational or multi-dimensional databases.

In many cases, users will want to “write back” to the data repository. It quickly becomes problematic for a user to do so because of a multiplicity of file formats, protection levels, context sensitive data, incompatible systems, and the like. This background information is not intended to identify problems that must be addressed by the claimed subject matter.

### SUMMARY

This summary is provided to introduce a selection of concepts in a simplified form that are further described below in the Detail Description Section. This summary is not intended to identify key features or essential features of the claimed subject matter, nor is it intended to be used as an aid in determining the scope of the claimed subject matter.

According to aspects of various described embodiments, implementations are provided for creating a mechanism to define how to present to end-users existing data, indicate where writing is possible, capture the user input, and later submit the changed data back to the data repository. Accordingly, a “Form” is defined, which provides a “report with data entry” area. A language such as RDL (Report Definition Language) can be used to define such forms. In one aspect, a metadata schema for report and form definition is defined. Forms are created using the language of the defined metadata schema. The forms include instructions for formatting or changing stored data. Permissions can be associated with the form to allow defined sections of the stored data to be changed. The form can then be accessed or stored for access.

According to another aspect, a computer-implemented system includes a metadata manager for parsing a metadata schema and operating on metadata in accordance with the parsed schema. The system also includes a form generator for producing forms using the language of the defined metadata schema and an application that receives instructions from the metadata manager and renders stored data in response to the received instructions.

According to another aspect, a computer-implemented system includes means for parsing a metadata schema for report and form definition. Means for associating locations of data to be changed are used to allow defined sections of the stored data to be changed.

Embodiments may be implemented as a computer process, a computer system (including mobile handheld computing devices) or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 illustrates an exemplary form 100 that can accept user input for modifying data contained in a client, according to one embodiment.

FIG. 2 illustrates an exemplary system 200 for rendering data in accordance with a metadata schema, according to one embodiment.

FIG. 3 illustrates an operational flow 300 for defining forms, according to one embodiment.

FIG. 4 illustrates a general computer environment 400, which can be used to implement the techniques described herein.

### DETAILED DESCRIPTION

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

RDL (Report Definition Language) is an XML-based schema that has been designed for standardizing report generation and maintenance. Reports can be generated that allow inspection of data that can come from several sources. However, most conventional report languages allow a user to only create reports that show data. The data can come from several arbitrary data sources, which can then be obtained and displayed using RDL.

RDL can further be used to format the data. For example, bolding and assigning colors can be independently assigned for individual data items. However, users often would like to be able to write back data to the data source. Conventional scenarios for writing back typically use a private format or an additional technology that is often not published. Accordingly, users are typically restricted from having the ability or public knowledge of a web form that will allow them to write back to a database.

In many cases people are required to, for example, invent a new language to describe a form. A form is typically a report of data being shown to a user but also allows the user to enter data in the form such that the entered data can be written back to a desired place. Accordingly, forms can be used to display data to the user such that the user can enter data in response.

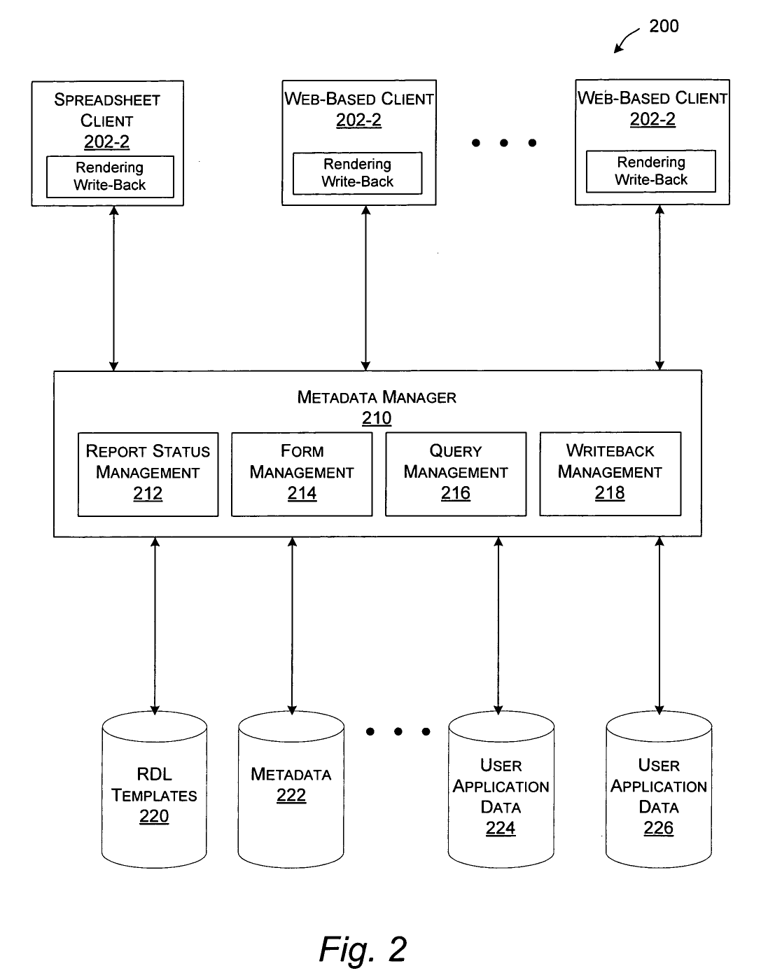

The report services definition language can be extended in accordance with the present invention and can be used to both create forms and define forms. By extending RDL to allow the definition of forms, it is possible to use “design-time” specified data entry regions and the runtime permissions that the user has in the data source such that forms can be handled in new ways. RDL can be used to parse SQL-like language such that data from data sources can be presented, for example, in a matrix on the screen and be used to define a form. By using an optional permissions mechanism, data sources can be automatically located in “back end” servers (see FIG. 2, item 220, for example) and securely written to. (Although some components herein are described as “servers” or “clients,” these terms are not limiting as the functions of the components can be allocated either fully or in part to various clients and servers.)

For example, forms can be created for “Enterprise Business Performance Management Suite” (Microsoft® Business Intelligence Application Suite) by using the XML file format for RDL as the persistence medium for the definition of the Enterprise Business Performance Management Suite forms. The persistence medium provides a mechanism to cross-reference form definitions to Microsoft® Excel® workbooks, which can be used in Enterprise Business Performance Management Suite as both the authoring, rendering and data entry surface.

In another example, an Excel® workbook can contain static data wherein changes to the data occur in response to a user's actions at a server. If the server-side data changes because of data processes (such as a calculation), the Excel spreadsheet program can access that data and refresh the data accordingly based on report definitions.

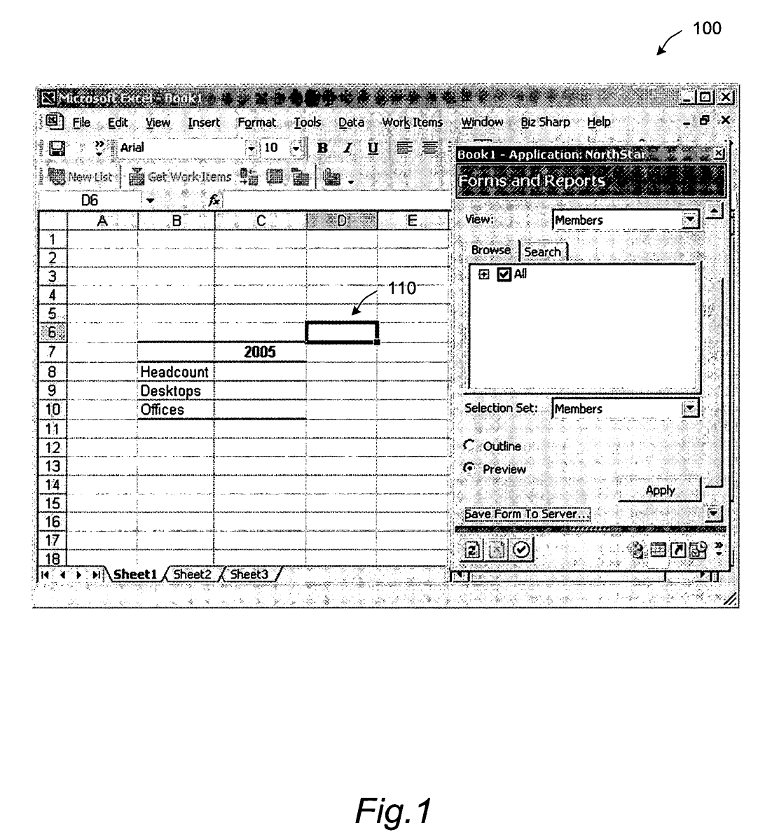

FIG. 1 illustrates an exemplary form 100 that can accept user input for modifying data contained in a client, according to one embodiment. In this embodiment, form 100 is a rendering in an Excel® workbook of a form defined in the RDL with Enterprise Business Performance Management Suite. The rendering can be performed by a computer that is separate from the computer that the user is operating, although all or some of the computing components can be located in the same system.

In operation, a user invokes the client by, for example, requesting data that resides on the server. Alternatively, the user can create a form template that references the data stored on the server, such that the user (or subsequent users) can access and manipulate the data in accordance with a desired format. The server renders the page in accordance with the RDL schema, and a metadata manager presents the requested information to the user.

The rendered page comprises cells, such as Cell 110 (at location D6). Cells at locations C8-C10 (for example) can accept user input and provide the data to be written back to the server. The location D6 can be provided as an anchor point such that the server knows which location the data should be written to.

FIG. 2 illustrates an exemplary system 200 for rendering data in accordance with a metadata schema, according to one embodiment. In this embodiment, system 100 comprises a number of clients 202, which can be clients used for back end data processing. The clients may run various programs such as spreadsheets, data base programs, web-based applications, and the like. Clients 202 operate in response to commands and requests from Metadata Manager 210, which in turn can access “back-end” data stores/servers such as RDL Templates 220 (for generating reports), metadata 222 (for defining metadata functions), application data (224 and 226) and the like.

In operation, the clients (202) typically communicate with user application programs (e.g., 224) using a middle-tier metadata manager (210) via (for example) open web services protocols. RDL is used by the metadata manager (210) to access the stored data (such as the metadata, application data, report definitions, RDL templates, and the like) to provide common interface for interpreting and handling the various kind of data.

All metadata typically is handled via the metadata manager (210) which performs functions of metadata management such as report status management 212, form management 214, query management 216, and write-back management 218. The metadata manager (210) can be instantiated one or more times simultaneously in response to parsing a form.

The report (212) and the form (214) management can access the metadata in case some data has changed, and the form (214) management can propagate out all the changes. The query management (216) can be used for reporting cell-based and data base information. The write-back management (218) can be used to validate a user's input so that the information can be correctly written back to the server. For example, information can be entered into an Excel® client, and the writeback process validates the user's input and maps the input so that it will be correctly written to the server.

The form management (214) can create form templates that can be used such multiple computers can use the same template, but that every computer will write to a different instance while using the same template. The form management (214) is arranged to store and maintain the report definition with other type of metadata on the back end. Part of creating the form includes linking the metadata to the rendering surface so that the data to be accessed is properly addressed. The linking can use an anchor point (which can be an arbitrary cell location or a media specific rendering surface) to associate with a metadata definition.

For example, the user can send a query to the back end, which then can be used to access a report definition associated with the request and then determine what query to send and to determine which data sources should be queried. Accordingly, multiple data sources can be queried in response to a single request. The query can be answered by a variety of different clients, but the metadata manager can correctly assemble the answers based on the metadata that is associated with the query.

In answering the query, the clients render the data and often use the write-back functionality so that the data can be changed in accordance with the back end metadata. In data entry, for example, once the form or report is rendered, the rendering sends the query to the back end. The data is rendered based the metadata, which contains information used to determine in which cells the user is allowed to enter data and in which cells the user is not allowed to enter data.

As an example, users can only enter certain business information at certain times of the year and/or month. Typically users can only enter a monthly forecast at the beginning of the month. These restrictions can be captured in the metadata and data report definitions. After rendering by the clients, the users can then start interacting with data from the clients. The clients can capture exactly where they wrote and map the answer using an anchor point to figure out to which cell, for example, in Excel® that corresponds to the data that the user entered. Accordingly, all entered data can be mapped and locations where data is to be written recorded so that the write-back management can eventually write back to the data storage at the correct times of the business cycle. Filters can be for selecting subsets of stored data and/or choosing conversion routines (such as for Celsius, metric system, foreign currency and the like).

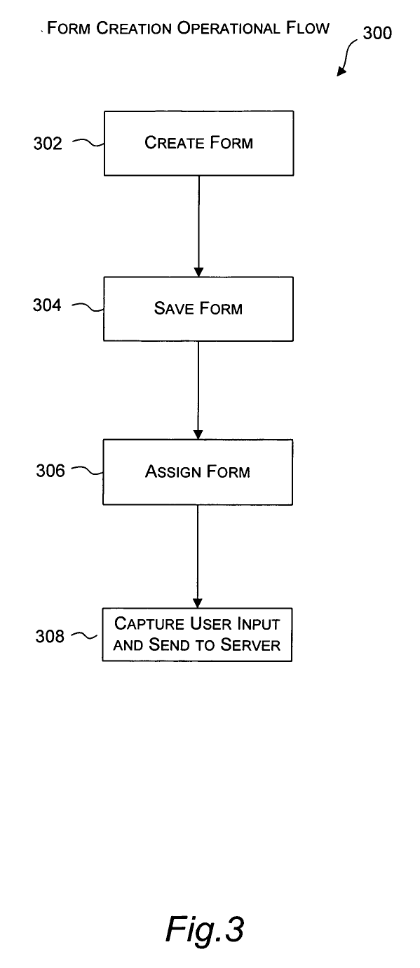

Exemplary “Metadata-Based Form Rendering and Write-Back” Operational Flow FIG. 3 illustrates an operational flow 300 for defining forms, according to one embodiment. Operational flow 300 may be performed in any suitable computing environment. For example, operational flow 300 may be executed by an application such as user application 224 (FIG. 2) to define a form. Therefore, the description of operational flow 300 may refer to at least one of the components of FIG. 2. However, any such reference to components of FIG. 2 is for descriptive purposes only, and it is to be understood that the implementations of FIG. 2 are a non-limiting environment for operational flow 300.

At a block 302, a form is created. In one embodiment, a user authors a “report” (read-only presentation of data) or “form” (“report with data entry areas”) in the Enterprise Business Performance Management Suite Add-In for Excel (“Add-In”). While authoring the form, the Add-In keeps in memory a map of what is being defined by the user to the corresponding RDL representation. In one embodiment, an application such as application 224 (FIG. 2) is used to create the file. In some embodiments, the user can create the file directly.

At a block 304, the user saves the form. The workbook is saved with an embedded identifier of the “form definition” (in RDL). In one embodiment, Data is saved to a database to capture both the “form definition” and the location of the workbook. The saved data might contain extra data not otherwise captured in the Copies of the original “form definition” so a corresponding workbook can be created and “assigned” for a user to enter data.

At block 306, the user opens the “assignment” in which its data input is requested. In one embodiment, the “form definition” is rendered in the workbook. A request to the Enterprise Business Performance Management Suite server is sent to retrieve information about which cell in the form the current user has permissions to write to. The permissions information is combined with any additional information (such as time sensitive cells) about which cells should be written is present in the “form definition”. The intersection of the two sets can be presented to the user as “writeable area.

At block 308, the user enters data and submits its data back to the Enterprise Business Performance Management Suite server. In this situation, the Enterprise Business Performance Management Suite server generates specific transactions to the clients based on the type of information requested and the received permission. The clients render data in response to the specific transactions and provide the data for rendering to the server.

Illustrative RDL Code

An example of extensions to an RDL-based schema for allowing forms to be rendered and written back is given below. The illustrative RDL code adds custom fields to the “Matrix” element of conventional RDL. The custom fields are used to allow the definition of metadata that is used to render the form (such as offsets for the data grid) and for including and excluding scopes in the input area. For example:

```
<Custom>
  <MatrixCustom xmlns=“http://schemas.microsoft.com/oba/
  2005/06/formdefinition”>
    <CaptureDesignTimeFormulas>false</CaptureDesignTimeFormulas>
    <DataGridOffsetLeft>2</DataGridOffsetLeft>
    <DataGridOffsetTop>2</DataGridOffsetTop>
    <ExclusiveScope />
    <InclusiveScope />
    <RequiredWriteback>false</RequiredWriteback>
    <Worksheet>Sell-Thru Forecast</Worksheet>
  </MatrixCustom>
</Custom>
```

Illustrative Operating Environment

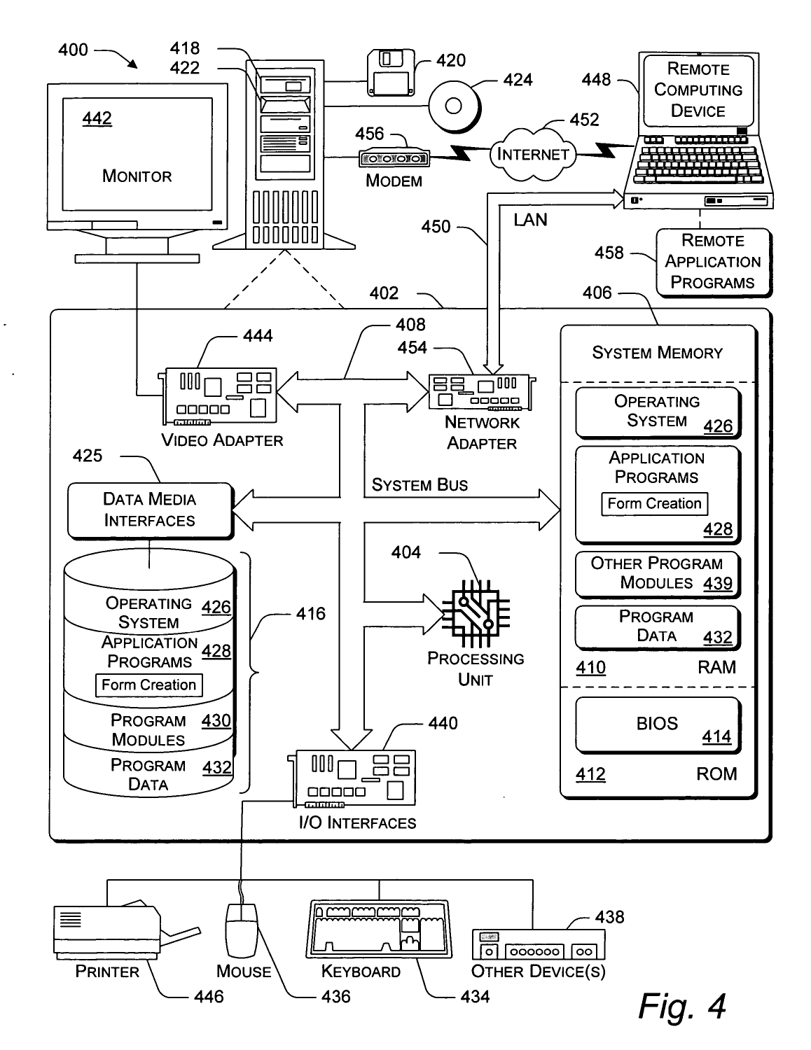

FIG. 4 illustrates a general computer environment 400, which can be used to implement the techniques described herein. The computer environment 400 is only one example of a computing environment and is not intended to suggest any limitation as to the scope of use or functionality of the computer and network architectures. Neither should the computer environment 400 be interpreted as having any dependency or requirement relating to any one or combination of components illustrated in the example computer environment 400.

Computer environment 400 includes a general-purpose computing device in the form of a computer 402. The components of computer 402 can include, but are not limited to, one or more processors or processing units 404, system memory 406, and system bus 408 that couples various system components including processor 404 to system memory 406.

System bus 408 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, a Peripheral Component Interconnects (PCI) bus also known as a Mezzanine bus, a PCI Express bus, a Universal Serial Bus (USB), a Secure Digital (SD) bus, or an IEEE 1394, i.e., FireWire, bus.

Computer 402 may include a variety of computer readable media. Such media can be any available media that is accessible by computer 402 and includes both volatile and non-volatile media, removable and non-removable media.

System memory 406 includes computer readable media in the form of volatile memory, such as random access memory (RAM) 410; and/or non-volatile memory, such as read only memory (ROM) 412 or flash RAM. Basic input/output system (BIOS) 414, containing the basic routines that help to transfer information between elements within computer 402, such as during start-up, is stored in ROM 412 or flash RAM. RAM 410 typically contains data and/or program modules that are immediately accessible to and/or presently operated on by processing unit 404.

Computer 402 may also include other removable/non-removable, volatile/non-volatile computer storage media. By way of example, FIG. 4 illustrates hard disk drive 416 for reading from and writing to a non-removable, non-volatile magnetic media (not shown), magnetic disk drive 418 for reading from and writing to removable, non-volatile magnetic disk 420 (e.g., a “floppy disk”), and optical disk drive 422 for reading from and/or writing to a removable, non-volatile optical disk 424 such as a CD-ROM, DVD-ROM, or other optical media. Hard disk drive 416, magnetic disk drive 418, and optical disk drive 422 are each connected to system bus 408 by one or more data media interfaces 425. Alternatively, hard disk drive 416, magnetic disk drive 418, and optical disk drive 422 can be connected to the system bus 408 by one or more interfaces (not shown).

The disk drives and their associated computer-readable media provide non-volatile storage of computer readable instructions, data structures, program modules, and other data for computer 402. Although the example illustrates a hard disk 416, removable magnetic disk 420, and removable optical disk 424, it is appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the example computing system and environment.

Any number of program modules can be stored on hard disk 416, magnetic disk 420, optical disk 424, ROM 412, and/or RAM 410, including by way of example, operating system 426, one or more application programs 428 (which can include code for form creation as described above), other program modules 430, and program data 432. Each of such operating system 426, one or more application programs 428, other program modules 430, and program data 432 (or some combination thereof) may implement all or part of the resident components that support the distributed file system.

A user can enter commands and information into computer 402 via input devices such as keyboard 434 and a pointing device 436 (e.g., a “mouse”). Other input devices 438 (not shown specifically) may include a microphone, joystick, game pad, satellite dish, serial port, scanner, and/or the like. These and other input devices are connected to processing unit 404 via input/output interfaces 440 that are coupled to system bus 408, but may be connected by other interface and bus structures, such as a parallel port, game port, or a universal serial bus (USB).

Monitor 442 or other type of display device can also be connected to the system bus 408 via an interface, such as video adapter 444. In addition to monitor 442, other output peripheral devices can include components such as speakers (not shown) and printer 446 which can be connected to computer 402 via I/O interfaces 440.

Computer 402 can operate in a networked environment using logical connections to one or more remote computers, such as remote computing device 448. By way of example, remote computing device 448 can be a PC, portable computer, a server, a router, a network computer, a peer device or other common network node, and the like. Remote computing device 448 is illustrated as a portable computer that can include many or all of the elements and features described herein relative to computer 402. Alternatively, computer 402 can operate in a non-networked environment as well.

Logical connections between computer 402 and remote computer 448 are depicted as a local area network (LAN) 450 and a general wide area network (WAN) 452. Such networking environments are commonplace in offices, enterprise-wide computer networks, intranets, and the Internet.

When implemented in a LAN networking environment, computer 402 is connected to local network 450 via network interface or adapter 454. When implemented in a WAN networking environment, computer 402 typically includes modem 456 or other means for establishing communications over wide network 452. Modem 456, which can be internal or external to computer 402, can be connected to system bus 408 via I/O interfaces 440 or other appropriate mechanisms. It is to be appreciated that the illustrated network connections are examples and that other means of establishing at least one communication link between computers 402 and 448 can be employed.

In a networked environment, such as that illustrated with computing environment 400, program modules depicted relative to computer 402, or portions thereof, may be stored in a remote memory storage device. By way of example, remote application programs 458 reside on a memory device of remote computer 448. For purposes of illustration, applications or programs and other executable program components such as the operating system are illustrated herein as discrete blocks, although it is recognized that such programs and components reside at various times in different storage components of computing device 402, and are executed by at least one data processor of the computer.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

What is claimed is:

1. A computer-implemented method for form creation, the method comprising:
defining a metadata schema for report and form definition;
creating a form in accordance with a language of the defined metadata schema, wherein the form comprises instructions for formatting stored data;
associating permissions with the form to allow defined sections of the stored data to be changed; and
storing the form for access.

2. The method of claim 1 further comprising accessing the stored form, entering data on the stored form, mapping the entered data, and storing the mapped data with the stored data.

3. The method of claim 1 wherein the metadata schema contains RDL instructions for defining metadata used for form definition.

4. The method of claim 1 wherein the stored form is accessed by a spreadsheet program.

5. The method of claim 1 further comprising accessing the stored form when a change is to be made to the stored data.

6. The method of claim 5 wherein a user makes the change to the stored data.

7. The method of claim 5 wherein the stored data is rendered in a native form that is associated with a client that is configured to access the stored data.

8. The method of claim 1 wherein instructions for formatting data are validated against business rules.

9. A computer-implemented system for form creation, the system comprising:
a metadata manager for parsing a metadata schema and operating on metadata in accordance with the parsed schema;
a form generator for producing forms in accordance with a language of the defined metadata schema, wherein the form comprises instructions for formatting stored data; and
an application that is configured to receive instructions from the metadata manager and render stored data in response thereto.

10. The system of claim 9 wherein the form generator is further configured to receive data that is to be used to change data in the stored data.

11. The system of claim 9 wherein the metadata manager comprises an API that is configured to manage the production of forms.

12. The system of claim 9 wherein the metadata manager is instantiated a plurality of times in response to parsing a form.

13. The system of claim 9 wherein the form specifies a range of cells as an anchor point for modifying the stored data.

14. The system of claim 12 further comprising filters for selecting subsets of stored data.

15. A computer-implemented system for form creation, the system comprising:
means for parsing a metadata schema for report and form definition;
means for creating a form in accordance with a language of the defined metadata schema, wherein the form comprises instructions for formatting stored data;
means for associating locations of data to be changed with the form to allow defined sections of the stored data to be changed; and
means for storing the form for access.

16. The system of claim 15 further comprising means for accessing the stored form, entering data on the stored form, mapping the entered data, and storing the mapped data with the stored data.

17. The system of claim 15 further comprising means for accessing the stored form when a change is to be made to the stored data.

18. The system of claim 15 wherein the means for associating locations for the stored data uses a native format that is used for formatting the stored data.

19. The system of claim 18 further comprising means for rendering the stored data in a native form that is associated with a client that is configured to access the stored data.

20. The system of claim 18 further comprising means for formatting data validated against business rules.
